(19) United States
(12) Patent Application Publication
(10) Pub. No.: US 2026/0159688 A1
(43) Pub. Date: Jun. 11, 2026

(54) THERMOPLASTIC COMPOSITION

(71) Applicant: Lubrizol Advanced Materials, Inc, Cleveland, OH (US)

(72) Inventors: Dean Thetford, Norden (GB); Elliot Coulbeck, Bury (GB); SAŠA GREEN, Blackley (GB)

(73) Assignee: Lubrizol Advanced Materials, Inc, Cleveland, OH (US)

(21) Appl. No.: 18/705,654

(22) PCT Filed: Oct. 31, 2022
(86) PCT No.: PCT/US2022/048381

§ 371 Date: Apr. 29, 2024

Related U.S. Application Data
(60) Provisional application No. 63/274,174, filed on Nov. 1, 2021.

(51) Int. Cl. C08L 77/06; C08K 5/20; C08L 23/16

(52) U.S. Cl. CPC C08L 77/06; C08K 5/20; C08L 23/16; C08L 2203/30

(57) ABSTRACT

A composition including a particulate solid, a plastic material and a polymer, wherein the polymer is a polyamide with fatty terminal end groups; wherein the polyamide is a condensation reaction product of a diamine and a diacid; wherein the polymer has from 5 to 13 monomer units; wherein the diamine is a saturated C₂-C₁₂, linear, branched, or cyclic diamine; wherein the amine groups of the diamine are primary or secondary; wherein the diacid is a mixture of (i) a saturated C₂₀-C₅₀ branched carboxylic diacid, and (ii) a C₂-C₁₈ carboxylic diacid; and wherein each of the fatty terminal end groups are independently a C₆-C₃₆ linear or branched carbon chain which is attached to the polyamide via an amide or an imide bond.

### TECHNICAL FIELD

The invention relates to a composition containing a particulate solid, a plastic material (such as a thermoplastic polymer) and a polymer. The polymer may be capable of being a dispersant.

### BACKGROUND

Thermoplastics such as polypropylene, polyethylene, etc., are typically colored using pigment concentrates. The pigment concentrates may be referred to as masterbatches. These concentrates are prepared by mixing ingredients together and subjecting them to any of the processes commonly used for dispersing particulate solids in a plastic material, such as a thermoplastic polymer. Compounding or mixing in a twin-screw extruder is one such process. Masterbatches may contain up to 70% of pigment, and optionally other additives. Other additives may include waxes, dispersants, lubricants and/or UV stabilizers.

Production of masterbatches typically utilizes a pigment dispersed in a plastic material, such as a thermoplastic polymer, to ideally form fine particles with limited amounts of aggregates. However, aggregates are known to form from the pigments in the production of masterbatches. The presence of pigment aggregates may result in filter blocking of the extruder.

In addition, particular requirements are important for finished articles containing a thermoplastic polymer. The thermoplastic polymer may be in the form of, for example, a solid article, a film, or a fiber. In solid articles, acceptable dispersion of the pigment is necessary in order to maximize color development, maximize tinctorial strength and/or reduce speck levels. For films, incomplete dispersion of the pigment may lead to cracking, unwanted light scattering effects, and/or specks. In fibers, incomplete dispersion of the pigment may result in fiber breakage.

Previous work has been conducted to provide dispersants for pigments used in plastic materials, such as thermoplastic polymers. Conventional dispersants are becoming, or may become, undesirable, such as because of increased regulatory scrutiny of non-polymeric dispersants.

The disclosed technology, therefore, provides compositions which are able to reduce or minimize at least one of any of the technical challenges discussed above. These challenges may lead to less efficient processing in expensive extruder-type equipment, causing production costs to increase. The present subject matter therefore identifies polymers, and compositions including the polymers, wherein the polymers are capable of dispersing a pigment allowing a thermoplastic to have at least one of: (i) a reduction in aggregates and/or specks; (ii) a finer state of dispersion (for example, having a lower filter pressure value); (iii) acceptable/improved tinctorial strength and/or improved brightness; (iv) faster rates of dispersion; or (v) a polymeric dispersant.

### SUMMARY

The subject matter disclosed herein provides compositions comprising a particulate solid, a plastic material and a polymer, wherein the polymer is a polyamide with fatty terminal end groups; wherein the polyamide is a condensation reaction product of a diamine and a diacid; wherein the polymer has from 5 to 13 monomer units; wherein the diamine is a saturated C₂-C₁₂, linear, branched, or cyclic diamine; wherein the amine groups of the diamine are primary or secondary; wherein the diacid is a mixture of (i) a saturated C₂₀-C₅₀ branched carboxylic diacid, and (ii) a C₂-C₁₈ carboxylic diacid; and wherein each of the fatty terminal end groups are independently a C₆-C₃₆ linear or branched carbon chain which is attached to the polyamide via an amide or an imide bond.

Also provided are uses of a polymer as a dispersant in a composition further comprising a particulate solid and a plastic material, wherein the polymer is a polyamide with fatty terminal end groups; wherein the polyamide is a condensation reaction product of a diamine and a diacid; wherein the polymer has from 5 to 13 monomer units; wherein the diamine is a saturated C₂-C₁₂, linear, branched, or cyclic diamine; wherein the amine groups of the diamine are primary or secondary; wherein the diacid is a mixture of (i) a saturated C₂₀-C₅₀ branched carboxylic diacid, and (ii) a C₂-C₁₈ carboxylic diacid; and wherein each of the fatty terminal end groups are independently a C₆-C₃₆ linear or branched carbon chain which is attached to the polyamide via an amide or an imide bond.

Further provided are methods of using a polymer as a dispersant in a composition, comprising providing the polymer to the composition; wherein the composition comprises a particulate solid and a plastic material; wherein the polymer is a polyamide with fatty terminal end groups; wherein the polyamide is a condensation reaction product of a diamine and a diacid; wherein the polymer has from 5 to 13 monomer units; wherein the diamine is a saturated C₂-C₁₂, linear, branched, or cyclic diamine; wherein the amine groups of the diamine are primary or secondary; wherein the diacid is a mixture of (i) a saturated C₂₀-C₅₀ l branched carboxylic diacid, and (ii) a C₂-C₁₈ carboxylic diacid; and wherein each of the fatty terminal end groups are independently a C₆-C₃₆ linear or branched carbon chain which is attached to the polyamide via an amide or an imide bond.

The following embodiments of the present subject matter are contemplated:
1. A composition comprising a particulate solid, a plastic material and a polymer, wherein the polymer is a polyamide with fatty terminal end groups; wherein the polyamide is a condensation reaction product of a diamine and a diacid; wherein the polymer has from 5 to 13 monomer units; wherein the diamine is a saturated C₂-C₁₂, linear, branched, or cyclic diamine; wherein the amine groups of the diamine are primary or secondary; wherein the diacid is a mixture of (i) a saturated C₂₀-C₅₀ branched carboxylic diacid, and (ii) a C₂-C₁₈ carboxylic diacid; and wherein each of the fatty terminal end groups are independently a C₆-C₃₆ linear or branched carbon chain which is attached to the polyamide via an amide or an imide bond.
2. The composition of embodiment 1, wherein the polymer has a theoretical molecular weight of from 1,000 to 5,000 g/mol.
3 The composition of either of embodiment 1 or embodiment 2, wherein the polymer has from 5 to 7 monomer units.
4. The composition of any one of embodiments 1 to 3, wherein the diamine is a saturated C₄-C₁₂ linear, branched, or cyclic diamine.
5. The composition of any one of embodiments 1 to 4, wherein the diacid is a mixture of (i) 25 to 95 wt. % of the saturated C₂₀-C₅₀ branched carboxylic diacid, and (ii) 5 to 75 wt. % of the C₂-C₁₈ carboxylic diacid, based on the total weight of the diacid.
6. The composition of any one of embodiments 1 to 5, wherein the plastic material is a thermoplastic polymer.
7. The composition of any one of embodiments 1 to 6, wherein the plastic material is a thermoset resin or a thermoplastic resin.
8 The composition of any one of embodiments 1 to 7, wherein the particulate solid is a pigment.
9 The composition of any one of embodiments 1 to 8, wherein the particulate solid is present in the composition in an amount of 1 wt. % to 95 wt. %, based on the total weight of the composition.
10. The composition of any one of embodiments 1 to 9, wherein the polymer is present in an amount of 0.1 wt. % to 50 wt. %, based on the total weight of the composition.
11. The composition of any one of embodiments 1 to 10, wherein: (a) the polymer is present in an amount of 0.1 wt. % to 50 wt. %, based on the total weight of the composition; and (b) the plastic material comprises at least one of: (i) an amorphous poly-α-olefin, present in an amount of up to 90 wt. %, based on the total weight of the composition; (ii) a wax, present in an amount of up to 90 wt. %, based on the total weight of the composition; (iii) a crystalline polyolefin, present in an amount of up to 30 wt. %, based on the total weight of the composition; or (iv) a hydrogenated castor oil wax, present in an amount of up to 75 wt. %, based on the total weight of the composition; with the proviso that at least one of (i) or (ii) is present in an amount of at least 0.1 wt. %, based on the total weight of the composition.
12. The composition of embodiment 11, wherein the amorphous poly-α-olefin is a polyethylene/polypropylene mixture.
13. The composition of any one of embodiments 1 to 12, wherein at least 10 wt. % of the composition, based on the total weight of the composition, has a particle size fraction of 1 mm or less.
14. The composition of any one of embodiments 1 to 13, wherein at least 10 wt. % of the composition, based on the total weight of the composition, has a particle size fraction of from 50 nm to 1 mm.
15. The composition of any one of embodiments 1 to 14, wherein the polymer has an acid value of less than 10 mg KOH/g.
16. The composition of any one of embodiments 1 to 15, wherein the polymer has an amine value of less than 10 mg KOH/g.
17. Use of a polymer as a dispersant in a composition further comprising a particulate solid and a plastic material, wherein the polymer is a polyamide with fatty terminal end groups; wherein the polyamide is a condensation reaction product of a diamine and a diacid; wherein the polymer has from 5 to 13 monomer units; wherein the diamine is a saturated C₂-C₁₂, linear, branched, or cyclic diamine; wherein the amine groups of the diamine are primary or secondary; wherein the diacid is a mixture of (i) a saturated C₂₀-C₅₀ l branched carboxylic diacid, and (ii) a C₂-C₁₈ carboxylic diacid; and wherein each of the fatty terminal end groups are independently a C₆-C₃₆ linear or branched carbon chain which is attached to the polyamide via an amide or an imide bond.
18. A method of using a polymer as a dispersant in a composition, comprising providing the polymer to the composition; wherein the composition comprises a particulate solid and a plastic material; wherein the polymer is a polyamide with fatty terminal end groups; wherein the polyamide is a condensation reaction product of a diamine and a diacid; wherein the polymer has from 5 to 13 monomer units; wherein the diamine is a saturated C₂-C₁₂, linear, branched, or cyclic diamine; wherein the amine groups of the diamine are primary or secondary; wherein the diacid is a mixture of (i) a saturated C₂₀-C₅₀ l branched carboxylic diacid, and (ii) a C₂-C₁₈ carboxylic diacid; and wherein each of the fatty terminal end groups are independently a C₆-C₃₆ linear or branched carbon chain which is attached to the polyamide via an amide or an imide bond.
19. The method of embodiment 18, wherein the polymer has a theoretical molecular weight of from 1,000 to 5,000 g/mol.
20. The method of either of embodiment 18 or embodiment 19, wherein the polymer has from 5 to 7 monomer units.
21. The method of any one of embodiments 18 to 20, wherein the diamine is a saturated C₄-C₁₂ linear, branched, or cyclic diamine.
22. £ The method of any one of embodiments 18 to 21, wherein the diacid is a mixture of (i) 25 to 95 wt. % of the saturated C₂₀-C₅₀ branched carboxylic diacid, and (ii) 5 to 75 wt. % of the C₂-C₁₈ carboxylic diacid, based on the total weight of the diacid.

### DETAILED DESCRIPTION

Various features and embodiments of the present subject matter will be described below by way of non-limiting illustration.

The amount of each chemical component described herein is presented exclusive of any solvent or diluent oil, which may be customarily present in the commercial material, that is, on an active chemical basis, unless otherwise indicated. However, unless otherwise indicated, each chemical or composition referred to herein should be interpreted as being a commercial grade material which may contain the isomers, by-products, derivatives, and other such materials which are normally understood to be present in the commercial grade.

It is known that some of the materials described herein may interact in the final formulation, so that the components of the final formulation may be different from those that are initially added. For instance, metal ions (of, e.g., a detergent) may migrate to other acidic or anionic sites of other molecules. The products formed thereby, including the products formed upon employing the composition of the present subject matter in its intended use, may not be susceptible of easy description. Nevertheless, all such modifications and reaction products are included within the scope of the present subject matter; the present subject matter encompasses the composition prepared by admixing the components described herein.

As used herein, the indefinite article “a” is intended to mean one or more than one. As used herein, the phrase “at least one” means one or more than one of the following terms. Thus, “a” and “at least one” may be used interchangeably. For example “at least one of A, B or C” means that just one of A, B or C may be included, and any mixture of two or more of A, B and C may be included, in alternative embodiments.

As used herein, the term “about” means that a value of a given quantity is within ±20% of the stated value. In other embodiments, the value is within ±15% of the stated value. In other embodiments, the value is within ±10% of the stated value. In other embodiments, the value is within ±5% of the stated value. In other embodiments, the value is within ±2.5% of the stated value. In other embodiments, the value is within ±1% of the stated value. In other embodiments, the value is within a range of the explicitly-described value which would be understood by those of ordinary skill, based on the disclosures provided herein, to perform substantially similarly to compositions including the literal amounts described herein.

As used herein, the term “substantially” means that a value of a given quantity is within ±10% of the stated value. In other embodiments, the value is within ±5% of the stated value. In other embodiments, the value is within ±2.5% of the stated value. In other embodiments, the value is within ±1% of the stated value.

As used herein, the term “substantially free of” means that a component does not include any intentional addition of the material which the component is “substantially free of”. For example, the component may include a material which the component is “substantially free of” at no more than impurity levels, which may be the result of incomplete chemical reactions and/or unintended/undesired (but perhaps unavoidable) reaction products.

As used herein, the transitional term “comprising,” which is synonymous with “including,” “containing,” or “characterized by,” is inclusive or open-ended and does not exclude additional, un-recited elements or method steps. However, in each recitation of “comprising” herein, it is intended that the term also encompass, as alternative embodiments, the phrases “consisting essentially of” and “consisting of,” where “consisting of” excludes any element or step not specified and “consisting essentially of” permits the inclusion of additional un-recited elements or steps that do not materially affect the essential or basic and novel characteristics of the composition or method under consideration.

In certain embodiments, provided are compositions comprising a particulate solid, a plastic material and a polymer, wherein the polymer is a polyamide with fatty terminal end groups; wherein the polyamide is a condensation reaction product of a diamine and a diacid; wherein the polymer has from 5 to 13 monomer units; wherein the diamine is a saturated C₂-C₁₂, linear, branched, or cyclic diamine; wherein the amine groups of the diamine are primary or secondary; wherein the diacid is a mixture of (i) a saturated C₂₀-C₅₀ l branched carboxylic diacid, and (ii) a C₂-C₁₈ carboxylic diacid; and wherein each of the fatty terminal end groups are independently a C₆-C₃₆ linear or branched carbon chain which is attached to the polyamide via an amide or an imide bond. As used in these embodiments, the term “mixture” related to the diacids means that the diacid includes both the saturated C₂₀-C₅₀ branched carboxylic diacid and the C₂-C₁₈ carboxylic diacid in any amounts greater than 0, and does not imply that they are combined together at any particular point in time relative to the preparation of the polymer; they may be combined together and/or incorporated into the reaction to prepare the polymer at any suitable time during preparation of the polymer.

In certain embodiments, the polymer has from 5 to 13 monomer units, such as from 6 to 13 monomer units, such as from 7 to 13 monomer units, such as from 8 to 13 monomer units, such as from 9 to 13 monomer units, such as from 10 to 13 monomer units, such as from 11 to 13 monomer units, such as from 12 to 13 monomer units, such as from 5 to 12 monomer units, such as from 6 to 12 monomer units, such as from 7 to 12 monomer units, such as from 8 to 12 monomer units, such as from 9 to 12 monomer units, such as from 10 to 12 monomer units, such as from 11 to 12 monomer units, such as from 5 to 11 monomer units, such as from 6 to 11 monomer units, such as from 7 to 11 monomer units, such as from 8 to 11 monomer units, such as from 9 to 11 monomer units, such as from 10 to 11 monomer units, such as from 5 to 10 monomer units, such as from 6 to 10 monomer units, such as from 7 to 10 monomer units, such as from 8 to 10 monomer units, such as from 9 to 10 monomer units, such as from 5 to 9 monomer units, such as from 6 to 9 monomer units, such as from 7 to 9 monomer units, such as from 8 to 9 monomer units, such as from 5 to 8 monomer units, such as from 6 to 8 monomer units, such as from 7 to 8 monomer units, such as from 5 to 7 monomer units, such as from 6 to 7 monomer units, such as from 5 to 6 monomer units. In certain embodiments, the polymer has 5, 6, 7, 8, 9, 10, 11, 12, or 13 monomer units. When referring to the number of monomer units in the polymer, what is meant is the number of monomer units which are combined together via chemical reaction to form the polymer.

In certain embodiments, the diamine is a saturated C₂-C₁₂ (such as C₄-C₁₂, C₆-C₁₂, C₈-C₁₂, C₁₀-C₁₂, C₂-C₁₀, C₄-C₁₀, C₆-C₁₀, C₈-C₁₀, C₂-C₈, C₄-C₈, C₆-C₈, C₂- C₆, C₄-C₆, or C₂-C₄) linear, branched, or cyclic diamine. It is to be understood that the qualifiers “linear”, “branched”, and “cyclic” shall only apply to a particular embodiment if such an embodiment is chemically possible, as would be understood by one of ordinary skill in the relevant art. For example, it is not be possible for the diamine to be a saturated C₂ cyclic diamine, so such an embodiment should be considered to be excluded from the broader embodiments described in this paragraph. Suitable non-limiting examples of the diamine include ethylenediamine, diaminopropane, diaminobutane, diaminopentane, hexamethylenediamine, diaminooctane, diaminononane, diaminodecane, diaminododecane, piperazine, methylpiperazine, dimethylpiperazine, homopiperazine, and bis-(aminomethyl)-cyclohexane.

In certain embodiments, the diacid includes a saturated C₂₀-C₅₀ l (such as C₂₄-C₅₀, C₂₈-C₅₀, C₃₂-C₅₀, C₃₆-C₅₀, C₄₀-C₅₀, C₄₄-C₅₀, C₂₀-C₄₆, C₂₄-C₄₆, C₂₈-C₄₆, C₃₂-C₄₆, C₃₆-C₄₆, C₄₀-C₄₆, C₂₀-C₄₂, C₂₄-C₄₂, C₂₈-C₄₂, C₃₂-C₄₂, C₃₆-C₄₂, C₂₀-C₃₈, C₂₄-C₃₈, C₂₈-C₃₈, C₃₂-C₃₈, C₂₀-C₃₄, C₂₄-C₃₄, C₂₈-C₃₄, C₂₀-C₃₀, C₂₄-C₃₀, or C₂₀-C₂₆) branched carboxylic diacid. Suitable non-limiting examples of commercially-available C₂₀-C₅₀ diacids include the UNIDYME™ product range available from Kraton Corporation.

In certain embodiments, the diacid includes a C₂-C₁₈ (such as C₄-C₁₈, C₆-C₁₈, C₈-C₁₈, C₁₀-C₁₈, C₁₂-C₁₈, C₁₄-C₁₈, C₁₆-C₁₈, C₂-C₁₆, C₄-C₁₆, C₆-C₁₆, C₈-C₁₆, C₁₀-C₁₆, C₁₂-C₁₆, C₁₄-C₁₆, C₂-C₁₄, C₄-C₁₄, C₆-C₁₄, C₈-C₁₄, C₁₀-C₁₄, C₁₂-C₁₄, C₂-C₁₂, C₄-C₁₂, C₆-C₁₂, C₈-C₁₂, C₁₀-C₁₂, C₂-C₁₀, C₄-C₁₀, C₆-C₁₀, C₈-C₁₀, C₂-C₈, C₄-C₈, C₆-C₈, C₂- C₆, C₄-C₆, or C₂-C₄) carboxylic diacid. Suitable non-limiting examples of the C₂-C₁₈ diacids include oxalic acid, alonic acid, succinic acid, glutaric acid, adipic acid, pimelic acid, suberic acid, azelaic acid, sabacid acid, undecanedioic acid, decanedic acid, undecanedicarboxylic acid, dodecanedicarboxylic acid, and hexadecanedioic acid.

In certain embodiments, the diacid is a mixture of (i) 25 to less than 100 (such as 25 to 95, 25 to 90, 25 to 85, 25 to 80, 25 to 75, 25 to 70, 25 to 65, 25 to 60, 25 to 55, 25 to 50, 25 to 45, 25 to 40, 25 to 35, 25 to 30, 30 to less than 100, 30 to 95, 30 to 90, 30 to 85, 30 to 80, 30 to 75, 30 to 70, 30 to 65, 30 to 60, 30 to 55, 30 to 50, 30 to 45, 30 to 40, 30 to 35, 35 to less than 100, 35 to 95, 35 to 90, 35 to 85, 35 to 80, 35 to 75, 35 to 70, 35 to 65, 35 to 60, 35 to 55, 35 to 50, 35 to 45, 35 to 40, 40 to less than 100, 40 to 95, 40 to 90, 40 to 85, 40 to 80, 40 to 75, 40 to 70, 40 to 65, 40 to 60, 40 to 55, 40 to 50, 40 to 45, 45 to less than 100, 45 to 95, 45 to 90, 45 to 85, 45 to 80, 45 to 75, 45 to 70, 45 to 65, 45 to 60, 45 to 55, 45 to 50, 50 to less than 100, 50 to 95, 50 to 90, 50 to 85, 50 to 80, 50 to 75, 50 to 70, 50 to 65, 50 to 60, 50 to 55, 55 to less than 100, 55 to 95, 55 to 90, 55 to 85, 55 to 80, 55 to 75, 55 to 70, 55 to 65, 55 to 60, 60 to less than 100, 60 to 95, 60 to 90, 60 to 85, 60 to 80, 60 to 75, 60 to 70, 60 to 65, 65 to less than 100, 65 to 95, 65 to 90, 65 to 85, 65 to 80, 65 to 75, 65 to 70, 70 to less than 100, 70 to 95, 70 to 90, 70 to 85, 70 to 80, 70 to 75, 75 to less than 100, 75 to 95, 75 to 90, 75 to 85, 75 to 80, 80 to less than 100, 80 to 95, 80 to 90, 80 to 85, 85 to less than 100, 85 to 95, 85 to 90, 90 to less than 100, 90 to 95, or 95 to less than 100) wt. % of a saturated C₂₀-C₅₀ branched carboxylic diacid, and (ii) greater than 0 to 75 (such as 5 to 75, 10 to 75, 15 to 75, 20 to 75, 25 to 75, 30 to 75, 35 to 75, 40 to 75, 45 to 75, 50 to 75, 55 to 75, 60 to 75, 65 to 75, 70 to 75, greater than 0 to 70, 5 to 70, 10 to 70, 15 to 70, 20 to 70, 25 to 70, 30 to 70, 35 to 70, 40 to 70, 45 to 70, 50 to 70, 55 to 70, 60 to 70, 65 to 70, greater than 0 to 65, 5 to 65, 10 to 65, 15 to 65, 20 to 65, 25 to 65, 30 to 65, 35 to 65, 40 to 65, 45 to 65, 50 to 65, 55 to 65, 60 to 65, greater than 0 to 60, 5 to 60, 10 to 60, 15 to 60, 20 to 60, 25 to 60, 30 to 60, 35 to 60, 40 to 60, 45 to 60, 50 to 60, 55 to 60, greater than 0 to 55, 5 to 55, 10 to 55, 15 to 55, 20 to 55, 25 to 55, 30 to 55, 35 to 55, 40 to 55, 45 to 55, 50 to 55, greater than 0 to 50, 5 to 50, 10 to 50, 15 to 50, 20 to 50, 25 to 50, 30 to 50, 35 to 50, 40 to 50, 45 to 50, greater than 0 to 45, 5 to 45, 10 to 45, 15 to 45, 20 to 45, 25 to 45, 30 to 45, 35 to 45, 40 to 45, greater than 0 to 40, 5 to 40, 10 to 40, 15 to 40, 20 to 40, 25 to 40, 30 to 40, 35 to 40, greater than 0 to 35, 5 to 35, 10 to 35, 15 to 35, 20 to 35, 25 to 35, 30 to 35, greater than 0 to 30, 5 to 30, 10 to 30, 15 to 30, 20 to 30, 25 to 30, greater than 0 to 25, 5 to 25, 10 to 25, 15 to 25, 20 to 25, greater than 0 to 20, 5 to 20, 10 to 20, 15 to 20, greater than 0 to 15, 5 to 15, 10 to 15, greater than 0 to 10, 5 to 10, or greater than 0 to 5) wt. % of a C₂-C₁₈ carboxylic diacid, based on the total weight of the diacid.

In certain embodiments, each of the fatty terminal end groups are independently a C₆-C₃₆ (such as C₁₀-C₃₆, C₁₄-C₃₆, C₁₈-C₃₆, C₂₂-C₃₆, C₂₆-C₃₆, C₃₀-C₃₆, C₆-C₃₂, C₁₀-C₃₂, C₁₄-C₃₂, C₁₈-C₃₂, C₂₂-C₃₂, C₂₆-C₃₂, C₆-C₂₈, C₁₀-C₂₈, C₁₄-C₂₈, C₁₈-C₂₈, C₂₂-C₂₈, C₆-C₂₄, C₁₀-C₂₄, C₁₄-C₂₄, C₁₈-C₂₄, C₆-C₂₀, C₁₀-C₂₀, C₁₄-C₂₀, C₆-C₁₆, C₁₀-C₁₆, or C₆-C₁₂) linear or branched carbon chain.

Suitable compounds which may be used to form the fatty terminal end groups include, without limitation: fatty acids and/or their methyl/ethyl esters; fatty amines (such as hexylamine, octylamine, stearamine, decylamine, and/or nonanamine); and/or fatty acid anhydrides (such as dodecyl succinic anhydride, hexadecyl succinic anhydride, octadecyl succinic anhydride, dodecenyl succinic anhydride, hexadecenyl succinic anhydride, octadecenyl succinic anhydride, and/or Pentasize™ 68 from Pentagon).

Suitable examples of fatty acids and/or their methyl/ethyl esters include, without limitation, myristic acid, oleic acid, palmitic acid, erucic acid, behenic acid, Versatic™ acid 911 (may also be described as a C₉₋₁₁-branched fatty acid), Versatic™ acid 10 (may also be described as tert-decanoic acid), ricinoleic acid, 12-hydroxystearic, 9,11-linoleic acid, 9,12-linoleic acid, 9,12,15-linolenic acid, abietic acid, hexanoic acid, octanoic acid, lauric acid, decanoic acid, stearic acid, 2-ethylbutyric acid, 2-ethylhexanoic acid, 2-butyloctanoic acid, 2-hexyldecanoic acid, 2-octyldodecanoic acid, 2-decyltetradecanoic acid, or mixtures thereof. Branched alkyl carboxylic acids of this type are available under the trade mark Isocarb® (from Sasol GmbH) and specific examples are Isocarb® 12, 16, 20, 28, 32, 34T and 36. Many of the carboxylic acids are available commercially as mixtures. Further examples of fatty acids include the Unicid® acids (linear primary synthetic carboxylic acids) commercially available from Baker Petrolite Polymer Division.

Other examples of suitable fatty acids include, without limitation, mixtures of fatty acids derived from oils from naturally occurring sources such as sunflower oil, olive oil, rapeseed oil, castor oil, palm oil, coconut oil, linseed oil, soya bean oil, fish oil and the like, in either a hydrogenated (saturated) or unsaturated form.

In certain embodiments, the fatty terminal end group may be selected from one or more of the types of compounds described above based on the nature of the polyamide portion. For example, if a diamine is used in excess, the fatty terminal group may be selected from at least one of the fatty acids and/or their methyl/ethyl esters or the fatty acid anhydrides; or, if a diacid is used in excess, the fatty terminal group may be selected from at least one of the fatty amines.

In certain embodiments, the polymer has a theoretical molecular weight of from 1,000 to 5,000 g/mol, such as from 1,500 to 5,000 g/mol, from 2,000 to 5,000 g/mol, from 2,500 to 5,000 g/mol, from 3,000 to 5,000 g/mol, from 3,500 to 5,000 g/mol, from 4,000 to 5,000 g/mol, from 4,500 to 5,000 g/mol, from 1,000 to 4,500 g/mol, from 1,500 to 4,500 g/mol, from 2,000 to 4,500 g/mol, from 2,500 to 4,500 g/mol, from 3,000 to 4,500 g/mol, from 3,500 to 4,500 g/mol, from 4,000 to 4,500 g/mol, from 1,000 to 4,000 g/mol, from 1,500 to 4,000 g/mol, from 2,000 to 4,000 g/mol, from 2,500 to 4,000 g/mol, from 3,000 to 4,000 g/mol, from 3,500 to 4,000 g/mol, from 1,000 to 3,500 g/mol, from 1,500 to 3,500 g/mol, from 2,000 to 3,500 g/mol, from 2,500 to 3,500 g/mol, from 3,000 to 3,500 g/mol, from 1,000 to 3,000 g/mol, from 1,500 to 3,000 g/mol, from 2,000 to 3,000 g/mol, from 2,500 to 3,000 g/mol, from 1,000 to 2,500 g/mol, from 1,500 to 2,500 g/mol, from 2,000 to 2,500 g/mol, from 1,000 to 2,000 g/mol, from 1,500 to 2,000 g/mol, or from 1,000 to 1,500 g/mol. As used herein when referring to the subject polymer, the term “theoretical molecular weight” means an average molecular weight of the subject polymer determined by (1) calculating the molecular weight of each monomer unit in the polymer based on the chemical formula of the monomer unit, (2) adding together the molecular weight of each monomer unit in the polymer, and (3) subtracting out any atoms/molecules which may be lost (such as water) when the monomer units are reacted together to form the subject polymer or precursor(s) thereof.

In certain embodiments, the plastic material is a thermoplastic polymer.

In certain embodiments, the plastic material is a thermoset resin or a thermoplastic resin.

In certain embodiments, the particulate solid is a pigment.

In certain embodiments, the particulate solid is present in the composition in an amount of 1 wt. % to 95 wt. %, based on the total weight of the composition.

In certain embodiments: (a) the polymer is present in an amount of 0.1 wt. % to 50 wt. %, based on the total weight of the composition; (b) the plastic material comprises at least one of: (i) an amorphous poly-α-olefin, present in an amount of up to 90 wt. %, based on the total weight of the composition; (ii) a wax, present in an amount of up to 90 wt. %, based on the total weight of the composition; (iii) a crystalline polyolefin, present in an amount of up to 30 wt. %, based on the total weight of the composition; or (iv) a hydrogenated castor oil wax, present in an amount of up to 75 wt. %, based on the total weight of the composition; with the proviso that at least one of (i) or (ii) is present in an amount of at least 0.1 wt. %, based on the total weight of the composition. In certain embodiments, the amorphous poly-α-olefin is a polyethylene/polypropylene mixture.

In certain embodiments, at least 10 wt. % of the composition, based on the total weight of the composition, has a particle size fraction of 1 mm or less.

In certain embodiments, at least 10 wt. % of the composition, based on the total weight of the composition, has a particle size fraction of from 50 nm to 1 mm.

In certain embodiments, the subject polymer may have a small amount of residual acidic or basic functionality. In certain embodiments, the polymer has an acid value of less than 10 mg KOH/g, such as less than 5 mg KOH/g, or less than 2.5 mg KOH/g. In certain embodiments, the polymer has an amine value of less than 10 mg KOH/g, such as less than 5 mg KOH/g, or less than 2.5 mg KOH/g. These embodiments may occur, for example, by reaction to make the polymer not progressing to 100% completion, or by there being a slight molar difference between the amount of amines and acid functionalities.

Also provided are uses of the polymers described above as dispersants in the compositions described above.

Also provided are methods of dispersing a particulate solid in a plastic material using the subject polymer described above. For example, the polymer, particulate solid and plastic material may be mixed together in any order to form a composition as described in the various embodiments provided above. In certain embodiments, the ingredients may be mixed together such that the particulate solid is added to the mixture last.

Further provided are methods of using the polymers described above as dispersants in the compositions described above.

In certain embodiments, the polymers of any of the embodiments described above may be suitable for use as a processing aid or dispersant for particulate solids, such as pigment materials, incorporated into compositions, for example plastic materials, such as thermoplastic polymers.

In certain embodiments, the polymers described herein may be present in such compositions in an amount of 0.1 wt. % (such as 0.2, 0.3, 0.4, 0.5, 0.6, 0.7, 0.8, 0.9, 1, 1.5, 2, 2.5, 3, 3.5, 4, 4.5, 5, 6, 7, 8, 9, 10, 15, 20, or 25 wt. %) to 50 wt. % (such as 45, 40, 35, or 30 wt. %), based on the total weight of the composition.

In certain embodiments, the particulate solid present in the compositions may be any inorganic or organic solid material. In certain embodiments, the particulate solid may be at least one of a pigment, an extender, a filler, a flame-retardant material, a ceramic material, a magnetic material, or metal particles. In certain embodiments, the particulate solid is a pigment, such as an inorganic pigment or an organic pigment.

In certain embodiments, the particulate solid may be an organic pigment, such as any of the recognized classes of pigments described in the Third Edition of the Colour Index (1971) and subsequent revisions of, and supplements thereto, under the chapter entitled “Pigmnets”.

Non-limiting examples of suitable organic pigments are at least one pigment from the azo, disazo, trisazo, condensed azo, azo lakes, naphthol, anthrapyrimidine, benzimidazolone, carbazole, diketopyrrolopyrrole, flavanthrone, indigoid, isoindolinone, isoindoline, isoviolanthrone, metal complex, oxazine, perylene, perinone, pyranthrone, pyrazoloquinazolone, quinophthalone, triarylcarbonium, triphendioxazine, xanthene, thioindigo, indanthrone, isoindanthrone, anthanthrone, anthraquinone, isodibenzanthrone, triphendioxazine, quinacridone, or phthalocyanine pigment series, and/or lakes of acid, basic and mordant dyes, and carbon black. In certain embodiments, the organic pigment is at least one of phthalocyanines, such as copper phthalocyanine and/or its nuclear halogenated derivatives, monoazos, disazos, indanthrones, anthranthrones, quinacridones, diketopyrrolopyrroles, perylenes, or carbon black.

In certain embodiments, the inorganic particulate solids may include at least one of: extenders and/or fillers, such as talc, kaolin, montmorillonites including bentonites, hectorites, saponites, mica, silica, barytes, chalk; flame-retardant fillers, such as alumina trihydrate, natural magnesium hydroxide, or brucite; particulate ceramic materials, such as alumina, silica, zirconia, titania, silicon nitride, boron nitride, silicon carbide, boron carbide, mixed silicon-aluminum nitrides, and/or metal titanates; particulate magnetic materials, such as the magnetic oxides of transition metals, such as iron and chromium (e.g., gamma-Fe₂O₃, Fe₃O₄, and cobalt-doped iron oxides), calcium oxide, ferrites, such as barium ferrites; and/or metal particles, such as iron, nickel, cobalt, copper and alloys thereof.

Non-limiting examples of suitable inorganic pigments include at least one of metallic oxides, such as titanium dioxide (e.g., rutile titanium dioxide and/or surface-coated titanium dioxide), titanium oxides of different colors (such as yellow and black), iron oxides of different colors (such as yellow, red, brown and black), zinc oxide, zirconium oxide, aluminum oxide, oxymetallic compounds (such as bismuth vanadate, cobalt aluminate, cobalt stannate, cobalt zincate, zinc chromate and mixed metal oxides of manganese, nickel, titanium, chromium, antimony, magnesium, cobalt, iron and aluminum), Prussian blue, vermillion, ultramarine, zinc phosphate, zinc sulphide, molybdates and chromates of calcium and zinc, metal-effect pigments (such as aluminum flake, copper, and copper/zinc alloy), or pearlescent flake (such as lead carbonate and bismuth oxychloride).

In certain embodiments, thermoplastic polymers (such as thermoplastic resins) which may be included in the compositions described herein may include at least one of polyolefins, polyesters, polyamides, polycarbonates, polyurethanes, polystyrenics, poly(meth)acrylates, celluloses, or cellulose derivatives. These compositions may be prepared in a number of ways, such as by melt mixing or dry solid blending methods.

Non-limiting examples of a suitable thermoplastics include (low density, linear low density, or high density) polyethylene, polypropylene, polystyrene, polyethylene terephthalate (PET), polybutylene terephthalate (PBT), nylon 6, nylon 6-6, nylon 6-12, nylon 11, nylon 12, nylon 4-6, polymethylmethacrylate, polyethersulphone, polysulphone, polycarbonate, polyvinyl chloride (PVC), chlorinated polyvinyl chloride, thermoplastic polyurethane, ethylene vinyl acetate (EVA), Victrex PEEK™ polymers (such as oxy-1,4-phenylenoeoxy-1,4-phenylene-carbonyl-1, and/or 4-phenylene polymers), and acrylonitrile butadiene styrene polymers (ABS), and/or various other polymeric blends or alloys of the above materials and/or other thermoplastic polymers.

In certain embodiments, the compositions may contain from 1 to 95% by weight of the particulate solid, such as from 2% (e.g., 3%, 4%, 5%, 6%, 7%, 8%, 9%, 10%, 12%, 14%, 16%, 18%, 20%, 25%, 30%, 35%, 40%, or 45%) to 90% (e.g., 85%, 80%, 75%, 70%, 65%, 60%, 55%, or 50%) by weight, based on the total weight of the composition. For example, a composition in which the solid is an organic material, such as an organic pigment, may contain from 15 wt. % to 60 wt. % of the solid, based on the total weight of the composition, whereas a composition in which the solid is an inorganic material, such as an inorganic pigment, filler or extender, may contain from 40 wt. % to 90 wt. % of the solid, based on the total weight of the composition.

The compositions described herein may include one or more other ingredients such as at least one of antifogging agents, nucleators, blowing agents, flame retardants, process aids, surfactants, heat stabilizers, UV absorbers, fragrances, anti-microbial agents, biocides, impact modifiers, antioxidants, antistatic agents, coupling agents, foaming agents, mold-release agents, lubricants (external and internal), plasticizers, slip agents, UV stabilizers, viscosity depressants, dispersants other than the polymers of the present subject matter, and air-release agents.

The thermoplastic polymer/resin compositions described herein may be prepared by any methods known for preparing thermoplastic compositions. Thus, for example, a solid, thermoplastic polymer, and a dispersant may be mixed in any order, the mixture then being subjected to a mechanical treatment to reduce the particles of the solid to an appropriate size, for example, by Banbury mixing, ribbon blending, twin-screw extrusion, twin-roll milling, compounding in a Buss co-kneader, or similar equipment.

In certain embodiments, the compositions described herein may comprise (a) 0.1 to 50 wt. %, or 0.25 to 35 wt. %, and 0.5 to 30 wt. % of the polymer described above; (b) up to 90 wt. % (such as greater than 0 to 90 wt. %, or 0.1 wt. % to 90 wt. %, or 1 wt. % to 90 wt. %) of an amorphous poly-α-olefin, such as a polyethylene/polypropylene mixture; (c) up to 90 wt. % (such as greater than 0 to 90 wt. %, or 0.1 wt. % to 90 wt. %, or 1 wt. % to 90 wt. %) of a wax, such as a polyolefin wax, for example a polyethylene wax; (d) up to 30 wt. % (such as greater than 0 to 30 wt. %, or 0.1 wt. % to 30 wt. %, or 1 wt. % to 30 wt. %) of a crystalline polyolefin; and (e) up to 75 wt. % (such as greater than 0 to 75 wt. %, or 0.1 wt. % to 75 wt. %, or 1 wt. % to 75 wt. %) of a hydrogenated castor oil wax. In certain embodiments, at least one of (b) or (c) is present in an amount of at least 0.1 wt. %.

It is noted that certain embodiments described herein could theoretically be interpreted to include a total wt. % of all components of the compositions described herein which is greater than 100 wt. %, based on the total weight of any particular composition. Persons of ordinary skill in the relevant art would understand that it is impossible for a composition to include greater than 100 wt. % of all components of the composition, and as such any embodiments which may be perceived to include greater than 100 wt. % of all components are specifically excluded from the subject matter described herein. For example, if the composition may include (among other possible components) an amorphous poly-α-olefin present in an amount of up to 90 wt. %, a wax present in an amount of up to 90 wt. %, based on the total weight of the composition, the amount of each component would be selected such that the total wt. % of all components of the composition does not exceed 100 wt. % of the composition.

The polyolefin wax (such as a polyethylene wax) may be a carrier, co-agent or synergist.

In certain embodiments, provided are micronized compositions. In one embodiment, the compositions comprising at least one of (i) an amorphous poly-α-olefin, or (ii) a polyolefin wax, have a particle size fraction of at least 10 wt % having a diameter of 1 mm or less, or 0.5 mm or less, or 0.1 mm or less, or 0.05 mm or less. In certain embodiments, the particle size fraction may be 50 nm to 1 mm, or 100 nm to 0.05 mm.

A suitable use of the polymers described herein may be in the production of dispersible solids in powder particle and/or fiber particle form, particularly of dispersible pigments or polymeric fillers, where the particles are coated with the dispersant. Coatings of this kind, of both organic and inorganic solids, are carried out in a known way, for example as described in EP-A-0 270 126. In this case a solvent or emulsion medium may either be removed or remain in the mixture, forming pastes. These pastes are customary commercial products and may further comprise binder fractions and also further auxiliaries and additives. In the case of pigments it is possible to coat the pigment surface during or after the synthesis of the pigments, by, for example, adding the polymers described herein to a pigment suspension, or during or after the operation of pigment finish. Pigments pretreated in this way are notable for greater ease of incorporation and also for enhanced viscosity, flocculation and gloss performance and for higher colour strength, as compared with untreated pigments.

Other suitable uses of the polymers described herein include dispersants for paints, inks, and coatings, or in any other products in which the polymers may be suitably used as dispersants.

The compositions described herein may be treated as a “master batch”, and added to additional polymeric material when forming fabricated articles. The amount of “master batch” which is mixed with the additional polymeric material may vary over wide limits depending on the nature of polymeric material and the particulate solid. In different embodiments, the amount of “master batch” may be 0.5 to 50%, or 10 to 50%, or 20 to 50%, based on the total weight of the final plastic article. Although the plastic material used in preparing the “master batch” may differ from the further plastic material to which the “master batch” is added, but may be the same, depending on the desired final material. The use of “master batches” is especially useful where the plastic material includes polypropylene, polyethylene, polyethylene/polypropylene diene, ethyl vinyl acetate, polychloroprene, chlorinated polyethylene, chlorosulphonated polyethylene, poly vinyl chloride, natural and synthetic rubber such as butadiene-based elastomers (for instance butadiene-styrene, butadiene-acrylonitrile rubbers, polybutadiene), polyisoprene or natural rubber.

Except in the Examples, or where otherwise explicitly indicated or required by context, all numerical quantities in this description specifying amounts of materials, reaction conditions, molecular weights, number of carbon atoms, and the like, are to be understood as modified by the word “about”. It is to be understood that the upper and lower amount, range, and ratio limits set forth herein may be independently combined, and that any amount within a disclosed range is contemplated to provide a minimum or maximum of a narrower range in alternative embodiments (with the proviso, of course, that the minimum amount of a range must be lower than the maximum amount of the same range). Similarly, the ranges and amounts for each element of the subject matter disclosed herein may be used together with ranges or amounts for any of the other elements.

While certain representative embodiments and details have been shown for the purpose of illustrating the subject matter disclosed herein, it will be apparent to those skilled in this art that various changes and modifications may be made therein without departing from the scope of the subject matter. In this regard, the scope of the invention is to be limited only by the following claims.

1. A composition comprising a particulate solid, a plastic material and a polymer, wherein the polymer is a polyamide with fatty terminal end groups; wherein the polyamide is a condensation reaction product of a diamine and a diacid; wherein the polymer has from 5 to 13 monomer units; wherein the diamine is a saturated C₂-C₁₂, linear, branched, or cyclic diamine; wherein the amine groups of the diamine are primary or secondary; wherein the diacid is a mixture of (i) a saturated C₂₀-C₅₀ l branched carboxylic diacid, and (ii) a C₂-C₁₈ carboxylic diacid; and wherein each of the fatty terminal end groups are independently a C₆-C₃₆ linear or branched carbon chain which is attached to the polyamide via an amide or an imide bond.

2. The composition of claim 1, wherein the polymer has a theoretical molecular weight of from 1,000 to 5,000 g/mol.

3. The composition of claim 1, wherein the polymer has from 5 to 7 monomer units.

4. The composition of claim 1, wherein the diamine is a saturated C₄-C₁₂ linear, branched, or cyclic diamine.

5. The composition of claim 1, wherein the diacid is a mixture of (i) 25 to 95 wt. % of the saturated C₂₀-C₅₀ branched carboxylic diacid, and (ii) 5 to 75 wt. % of the C₂-C₁₈ carboxylic diacid, based on the total weight of the diacid.

6. The composition of claim 1, wherein the plastic material is a thermoplastic polymer.

7. The composition of claim 1, wherein the plastic material is a thermoset resin or a thermoplastic resin.

8. The composition of claim 1, wherein the particulate solid is a pigment.

9. The composition of claim 1, wherein the particulate solid is present in the composition in an amount of 1 wt. % to 95 wt. %, based on the total weight of the composition.

10. The composition of claim 1, wherein the polymer is present in an amount of 0.1 wt. % to 50 wt. %, based on the total weight of the composition.

11. The composition of claim 1, wherein:
a. the polymer is present in an amount of 0.1 wt. % to 50 wt. %, based on the total weight of the composition; and
b. the plastic material comprises at least one of:
i. an amorphous poly-α-olefin, present in an amount of up to 90 wt. %, based on the total weight of the composition;
ii. a wax, present in an amount of up to 90 wt. %, based on the total weight of the composition;
iii. a crystalline polyolefin, present in an amount of up to 30 wt. %, based on the total weight of the composition; or
iv. a hydrogenated castor oil wax, present in an amount of up to 75 wt. %, based on the total weight of the composition;
with the proviso that at least one of (i) or (ii) is present in an amount of at least 0.1 wt. %, based on the total weight of the composition.

12. The composition of claim 11, wherein the amorphous poly-α-olefin is a polyethylene/polypropylene mixture.

13. The composition of claim 1, wherein at least 10 wt. % of the composition, based on the total weight of the composition, has a particle size fraction of 1 mm or less.

14. The composition of claim 1, wherein at least 10 wt. % of the composition, based on the total weight of the composition, has a particle size fraction of from 50 nm to 1 mm.

15. The composition of claim 1, wherein the polymer has an acid value of less than 10 mg KOH/g and/or the polymer has an amine value of less than 10 mg KOH/g.
